(19) United States
(12) Patent Application Publication
(10) Pub. No.: US 2013/0264734 A1
(43) Pub. Date: Oct. 10, 2013

(54) METHODS OF RECYCLING WASTE RESIN PRODUCTS

(71) Applicant: KOJIMA SANGYO CO., LTD., Miyoshi-shi (JP)

(72) Inventors: Shigehito KATOH, Miyoshi-shi (JP); Michitsune ITOH, Miyoshi-shi (JP); Shinji TOHYAMA, Miyoshi-shi (JP)

(73) Assignee: KOJIMA SANGYO CO., LTD., Miyoshi-shi (JP)

(21) Appl. No.: 13/789,253

(22) Filed: Mar. 7, 2013

(30) Foreign Application Priority Data
Apr. 5, 2012 (JP) 2012-086311

(51) Int. Cl. B29B 17/04; B29C 47/00

(52) U.S. Cl. CPC B29B 17/0412; B29C 47/0004
USPC 264/37.1; 241/15

(57) ABSTRACT

A method of recycling a waste resin product having a coated film formed thereon, may include crushing the waste resin product into roughly crushed resin pieces; at least partially removing the coated film via a chemical process from the roughly crushed resin pieces; and further mechanically removing the coated film from the roughly crushed resin pieces by finely crushing the roughly crushed resin pieces. The process results in finely crushed resin pieces having their film coating substantially removed.

This application claims priority to Japanese patent application serial number 2012-86311, the contents of which are incorporated herein by reference.

### BACKGROUND OF THE INVENTION

1. Field of the Invention

Embodiments of the present invention relate to waste resin product recycling methods, in which a waste resin product having a coated film thereon and used primarily in automobiles is recycled as a reusable resin material.

2. Description of the Related Art

For example, a technique disclosed in JP-A-2003-268175 has been known as this kind of waste resin product recycling method. The technique disclosed in this publication is intended to recycle resin bumpers of automobiles. According to this technique, waste bumpers made of PP (polypropylene) and having coated films formed thereon are crushed into pieces, and thereafter, foreign substances such as metal particles are removed from the crushed bumper pieces. After removing the metal particles, the crushed bumper pieces are mixed with a virgin resin (non-recycled resin) and additives such as talc and are thereafter melted and molded into pellets containing the materials of the coated films. This process results in recycled resin material.

In the case of the technique of the above publication, the recycled resin material obtained from the waste bumpers may contain the materials of the coated films. Such materials may lower the physical property of the recycled resin material. Thus, because the crushed coated films are mixed into the recycled resin material, it may be possible that cracks may be produced where the materials of the coated films are contained. Products molded using recycled resin material typically have a low resistance against impacts. Furthermore, the materials of the coated films may be exposed on the surfaces of the products. If new coating layers are formed on the surfaces of the products, small lumps may be produced thereby degrading the quality of the products.

Therefore, there has been a need in the art for a technique that can recycle waste resin products without substantially containing coated film materials.

### SUMMARY OF THE INVENTION

In one aspect according to the present teachings, a method of recycling a waste resin product having a coated film formed thereon, may include roughly crushing the waste resin product into roughly crushed resin pieces; chemically removing the coated film at least partially from the roughly crushed resin pieces; and mechanically further removing the coated film from the roughly crushed resin pieces while crushing the roughly crushed resin pieces into fine resin pieces whereby the coated film is substantially removed.

### BRIEF DESCRIPTION OF THE DRAWINGS

FIG. 1 is a schematic view of a part of a waste material recycling line for performing an early process:

FIG. 2 is a schematic view of a part of the waste material recycling line for perform a later process;

FIG. 3 is a schematic flowchart showing primary steps of the recycling process; and

FIGS. 4(a), 4(b) and 4(c) are schematic views illustrating different removal states of a coated film caused when a solution is used for removal.

### DETAILED DESCRIPTION OF THE INVENTION

Each of the additional features and teachings disclosed above and below may be utilized separately or in conjunction with other features and teachings to provide improved methods of recycling waste resin products. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings. Various examples will now be described with reference to the drawings.

In one embodiment, a method for recycling a waste resin product having a coated film formed thereon, may include the following steps:
crushing the waste resin product into roughly crushed resin pieces;
immersing the roughly crushed resin pieces into a vessel containing a solvent, so that the coated film is at least partly removed from each of the roughly crushed resin pieces by a chemical action of the solvent;
transferring the roughly crushed resin pieces to a crusher immediately after removal of the coated film; and
crushing the roughly crushed resin pieces into finely crushed resin pieces by the crusher and promoting removal of the coated film by application of external dynamic energy to each of the resin pieces during crushing.

With this method, immediately after the coated film has been removed from the roughly crushed resin pieces by the chemical action of the solvent, the roughly crushed resin pieces are crushed into finely crushed resin pieces by the crusher while impacts occurring during crushing may act as external dynamic energy for promoting removal of the coated film. Hence, the coated film can be substantially removed from the crushed resin pieces. In this way, it is possible use recycled resin material to create a resin product substantially free of small fragments of the coated film. As a result, the resin product may be improved in resistance against impacts and also may be improved in its quality because fine garments of the coated film may not be exposed on the surface of the resin product.

The method may further include a step of washing the finely crushed resin pieces with water and thereafter separating the water from the finely crushed resin pieces. As the finely crushed resin pieces are washed, the coated film still adhered to the resin pieces may be washed off by impacts applied during the washing step. In addition, as the finely crushed resin pieces are separated from the water, the coated film removed from the resin pieces may be separated from the resin pieces and may be discharged to the outside together with water. In this way, the finely crushed resin pieces that do not contain the coated film can be fed to a next step, such as a palletizing step.

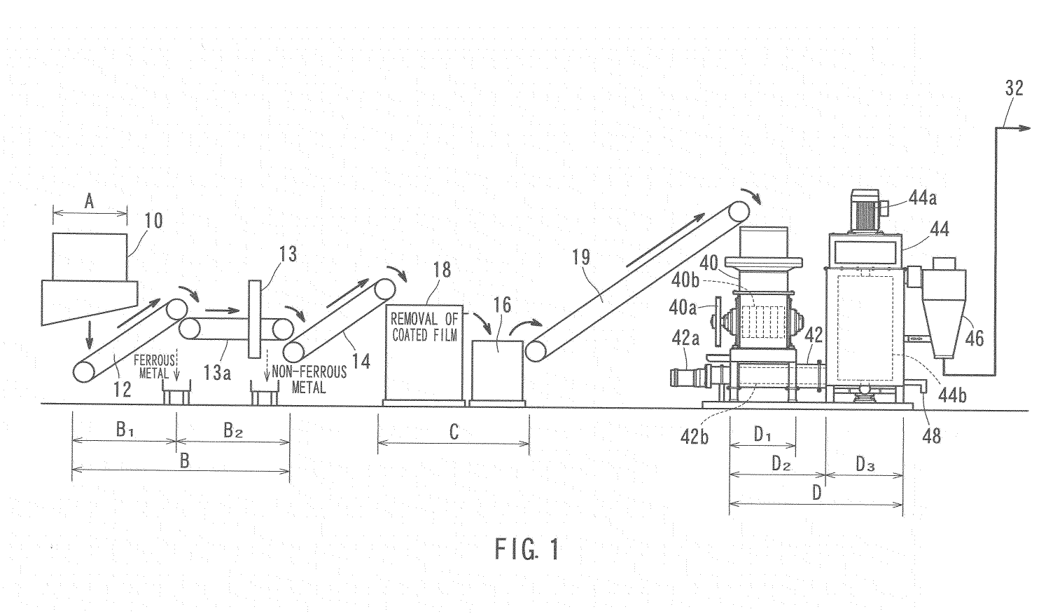

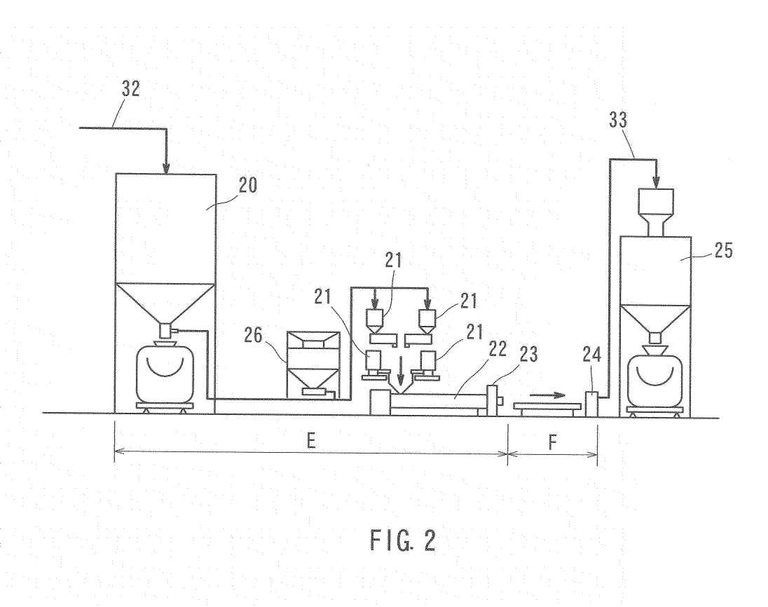

A representative embodiment will now be described with reference to the drawings. Referring to FIGS. 1 and 2, there is shown a schematic view of a production line for performing a representative method of recycling waste resin products having coated films. Such waster resin products may be resin bumpers, rocker moldings, etc., of automobiles. The waste resin products may be crushed into roughly crushed pieces by a crushing step A and may be thereafter transferred to a metal removing step B, a primary removing step C and a secondary removing step D shown in FIG. 1. After the secondary removing step D, the crushed pieces of the waste resin products may be transferred to a mixing and molding step E and a cutting step F, so that the waste resin products can be recycled as a reusable resin material. The roughly crushed resin pieces transferred from the crushing step A to the metal removing step B may still have pieces of the coated films adhered thereto. In addition, the roughly crushed resin pieces may contain various metal particles or fragments. For example, the metal parts may be screws, bolts, clips, brackets, antennas or wires, which are made of steel or aluminum.

In the crushing step A, the waste resin products may be supplied into a crusher 10, where the waste resin products may be crushed into roughly crushed resin pieces. The roughly crushed resin pieces may be transferred to a ferrous material removing step B1 in the metal removing step B. In the ferrous material removing step B1, the roughly crushed resin pieces may be supplied onto a magnet conveyor 12. During transportation on the magnet conveyor 12, ferrous parts that may be mixed in the roughly crushed resin pieces may be attracted by magnets and may be removed. The roughly crushed resin pieces, from which the ferrous parts have been removed, are transferred onto a conveyor 13a in a non-ferrous material removing step B2. The roughly crushed resin pieces then move through an arch-type non-ferrous material separator 13 during transportation by the conveyor 13a. During this step, non-ferrous metal parts that may be mixed in the roughly crushed resin pieces, may be removed. An example of non-ferrous parts are those made of aluminum. The arch-type non-ferrous material separator 13 may be configured to produce eddy currents in the non-ferrous metal parts that are electrically conductive. These eddy currents can generate forces for movement of the non-ferrous metal parts by way of electromagnetic induction. In this way, the non-ferrous metal parts may be removed from the roughly crushed resin pieces.

The roughly crushed resin pieces that may still have coated films may be transferred from the metal removing step B to the primary removing step C by a conveyer 14. In the primary removing step C, the roughly crushed resin pieces may be immersed into a solvent stored in a removing vessel 18 for a predetermined time. The solvent stored in the removing vessel 18 may primary contain water and a removing agent mixed with water for promoting removal of the coated films from the crushed resin pieces. More specifically, the removing agent may chemically act on the coated films to cause swelling of the same, so that the coated films may be at least partly removed from the crushed resin pieces. In the case that the waste resin product is made of polypropylene and the coated layer is a urethane coating with a primer, such as chlorinated polyethylene, it may be preferable that the removing agent may cause swelling of the primer. In this case, the removing agent may be chlorinated hydrocarbon, such as methylene chloride. Therefore, in this specification, the term “coated layer” is used to also include a primer in the case that a coating is formed on a surface of the resin product with an intervention of the primer. After removal of the coated films, the crushed resin pieces may be transferred from the removing vessel 18 to a dewatering apparatus 16. Here, the solvent is removed from the crushed resin pieces. In other words, the solvent is separated from the crushed resin pieces, for example through drainage. Alternatively, the crushed resin pieces can be physically removed from the solvent. After that, the crushed resin pieces may be transferred to a secondary removing step D by way of a conveyor 19.

As will be explained later, using the solution in the primary removing step C may result in complete or incomplete removal of the coated film from the crushed resin pieces.

In primary removing step C, coated film is removed from the roughly crushed resin pieces. The secondary removing step D may include a crushing step D1, a washing step D2 and a dewatering step D3. In the crushing step D1, the roughly crushed resin pieces may be supplied to a crusher 40 together with the removed coated films, so that the roughly crushed resin pieces and the removed coated films are finely crushed. The crusher 40 may have a rotary cutter 40b disposed inside of the crusher 40. The cutter 40b may be rotatably driven by a motor (not shown) via a pulley 40a. During the rotation of the cutter 40b, water may be injected into the crusher 40 from its upper side, so that the roughly crushed resin pieces can be finely crushed.

In washing step D2, the finely crushed resin pieces may be fed into a washing machine 42 disposed below the crusher 40. The washing machine 42 may include a motor 42a and an agitation screw 43b that is disposed within the washing machine 42 and is rotated by the motor 42a. As the agitation screw 42b rotates, the finely crushed resin pieces fed into the washing machine 42 may be washed with water and may be thereafter fed to a dewatering machine 44 during dewatering step D3

The dewatering machine 44 may remove water from the finely crushed resin pieces that were washed by the washing machine 42. For example, the dewatering machine 44 may include a motor 44a and a rotor 44b disposed within the dewatering machine 44 and rotatably driven by the motor 44a. The rotor 44b may have a plurality of blades. The finely crushed resin pieces may be dewatered as they move from a lower position toward an upper position along a spiral path in accordance with the rotation of the rotor 44b. After dewatering, mixing and molding step E occurs. In this step, the finely crushed resin pieces may be fed from the dewatering machine 44 into a stock tank 30 via a feeder 46 and a pipeline 32.

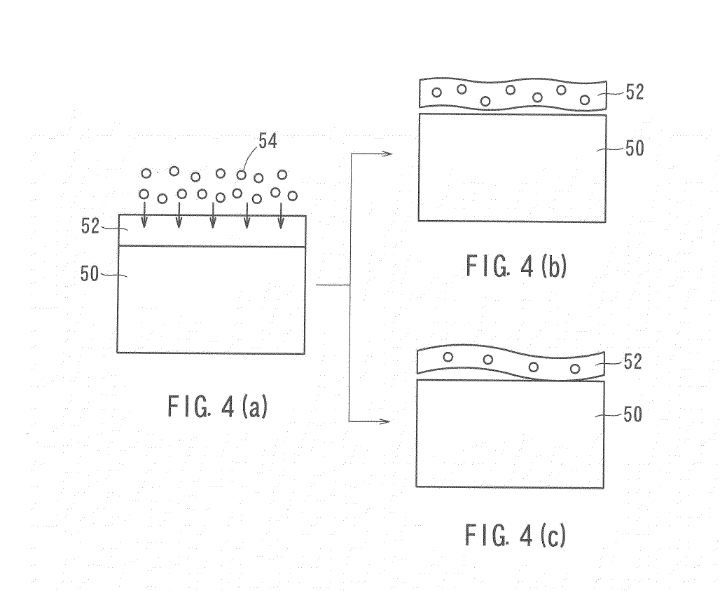

The chemical removal of the coated films using the solvent in the primary removing step C shown in FIG. 1 will be further described with reference to FIGS. 4(a), 4(b) and 4(c). For the purpose of explanation, the description will be made to one of roughly crushed resin pieces. As shown in FIG. 4(a), when a roughly crushed resin piece 50 (hereinafter simply called “resin piece 50”) having a coated film 52 is immersed into a solution 54, the coated film 52 may swell due to the chemical action of the solution 54 causing it to be removed from the resin piece 50. The coated film 52 may be completely removed from the resin piece 50 as shown in FIG. 4(b) or incompletely removed from the resin piece 50 as shown in FIG. 4(c), where a part of the coated film 52 still adheres to the surface of the resin piece 50. The removal state shown in FIG. 4(a) and the removal state shown in FIG. 4(b) will be hereinafter called a “complete removal state” and an “incomplete removal state”, respectively. Should the primary removing step C only result in the incomplete removal state, the coated film 52 may be substantially completely removed in the secondary removing step D. More specifically, in the crushing step D1 of the secondary removing step D, external dynamic energy from impacts and vibrations, may be applied to the resin piece 50 and the coated film 52, so that the coated film 52 can be substantially removed.

In the embodiment shown in FIG. 1, the roughly crushed resin pieces 50 may be supplied into the crusher 40 so as to be finely crushed in the crushing step D1. Therefore, impact forces and shearing forces may be applied as an external dynamic energy to the roughly crushed resin pieces 50. In this way, the coated film 52 can be effectively removed from the roughly crushed resin pieces 50 should the coated film 52 still exist in the incompletely removed state shown in FIG. 4(b). The removed coated film 52 may be washed off during the washing operation in the washing step D2. In the dewatering step D3, water and removed coated film 52 may be collected and discharged from the dewatering machine 44 via a discharge pipe.

During the crushing step D1 impact forces as well as shearing forces, vibrations and frictional forces may be applied as external dynamic energy to the roughly crushed resin pieces 50. During the washing step D2 and the dewatering step D3, vibrations, frictional forces and agitating forces may be applied as external dynamic energy to the finely crushed resin pieces 50.

As shown in FIG. 2, the finely crushed resin pieces from which the coated film has been removed in the secondary removing step D may be transferred to a stock tank 20 in the mixing and molding step E via a pipeline 32. A preparation hopper 26 may be located in the vicinity of the stock tank 20. Two different kinds of additives may be separately stored within the stock tank 20. In this embodiment, talc and pigment are used as additives. These additives and the crushed material may be respectively supplied to a twin screw extruder 22 via corresponding feeders 21.

The twin screw extruder 22 may have two screws rotating within a housing that can be heated to a given temperature. The additives and the crushed resin pieces supplied to the twin screw extruder 22 may be melted and mixed together to a form of paste within the housing. The paste may be extruded from the extruder 22 via a separation screen 23. As the paste mixture passes through the separation screen 23, foreign particles having diameters larger than about 100 μm may be removed while the mixture is formed into a plurality of strands.

In the cutting step F shown in FIG. 2, the strands extruded from the extruder 22 in the mixing and molding step E may be cut into pellets by a cutting machine 24. The pellets may then be fed into a product storage tank 25 via a pipeline 33 by using the flow of air flowing through the pipeline 33, so that the pellets can be stored in the product storage tank 25.

Preferably, the three kinds of materials, i.e., two additives and the crushed resin pieces, may be mixed together immediately before the mixture is supplied to the twin screw extruder 22 in order to obtain a recycled resin material that has a desired and stable physical property and eliminate such problems as described below.

In general, resin pellets have a diameter of about a few millimeters. However, it may be possible to mold resin pellets to have a diameter of about a dozen millimeters. Talc may be used as one of the additives. In order to conserve energy at the crushing step D1, the waste resin product may be crushed into pieces having a diameter of about 10 to 20 mm. In this situation, a large difference in the diameter between the crushed resin pieces and one of the additives may occur. Therefore, if the mixture of these materials (i.e., the mixture of the crushed resin pieces and two additives) is supplied into the hopper of the twin screw extruder 22, it is likely that the material having a smaller diameter than the others is fed into the extruder 22 earlier than the others. Alternatively, they may be deposited on the inner wall of the hopper (in the case that the additive is talk in a form like powder). If this occurs, the percentage of the materials contained in the molded product extruded from the extruder 22 may become unstable or non-uniform during the extrusion process. As a result, resin pellets may have different properties.

In contrast, according to the present embodiment, the crushed resin pieces and the additives are mixed immediately before they are supplied to the extruder 22. In this connection, the feeders 21 may be set to measure the weights of the crushed resin pieces and the additives such that the crushed resin pieces are contained in the mixture by an amount equal to or more than 95 wt % and the talc and the pigment as the additives are contained in the mixture by an amount equal to or less than 5 wt %. With this pre-determination of the percentages in weight of the materials, it is possible to produce resin pellets having a substantially uniform property with a specific gravity of 1.05±0.02, a melt flow rate of 30±10 g/10 min, and a Charpy impact value of 40 KJ/m² or more.

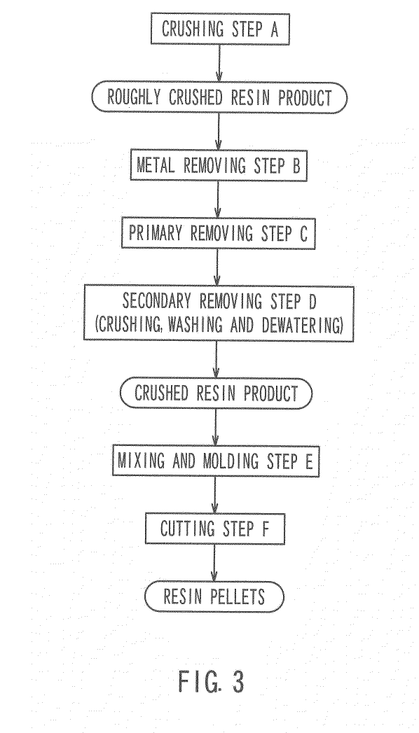

FIG. 3 is a schematic flow chart of a method for recycling a waste resin product, such as a waste resin bumper. It should be noted that the production lines shown in FIGS. 1 and 2 are examples of production lines that can be used for performing the process steps in FIG. 3. The production lines shown in FIGS. 1 and 2 are advantageously used because the crushed resin pieces are transferred from the secondary removing step D to the mixing and molding step E by way of the flow of air flowing through the pipeline 32. More specifically, the crushed resin pieces are transferred from the dewatering machine 44 in the dewatering step D3 to the stock tank 20 in the mixing and molding step E via the feeder 46 and the pipeline 32. Therefore, it is possible to inhibit foreign materials from being mixed into the crushed resin pieces during the transfer from the secondary removing step D to the mixing and molding step E. Hence, it is possible to prevent potential brakeage of strands due to the mixed foreign materials during extrusion by the extruder 22 in the mixing and molding step E.

The recycled resin pellets may be used as a material for molding bumpers, under covers, wheel covers, etc., of automobiles or any other resin mold products.

As described above, according to the representative method, the roughly crushed resin pieces are finely crushed in the secondary removing step D immediately after the primary removing step C. Additionally, external dynamic energy may be applied to the crushed resin pieces in the secondary removing step D. Therefore, as described previously with reference to FIG. 4, the coated film 52 that is in the incompletely removed state even after the primary removing step C can be substantially completely removed from the resin pieces 50. As a result, it is possible to prevent fine fragments of the coated films from being mixed into the recycled resin material.

Further, during the washing step D2 and the removing step D3 of the secondary removing step D, the coated film 52 may be washed off and separated to be discharged to the outside together with water. In this way, it is possible to substantially remove the coated film 52.

What is claimed is:

1. A method for recycling a waste resin product having a coated film formed thereon, comprising:
roughly crushing the waste resin product into crushed resin pieces;
immersing the crushed resin pieces into a coated film removing vessel containing a solvent, so that the coated film is at least partially removed from the crushed resin pieces by a chemical action of the solvent;
transferring the crushed resin pieces to a crusher after removal of the coated film; and
finely crushing the crushed resin pieces by the crusher and promoting removal of the coated film by applying an external dynamic energy to the crushed resin pieces during crushing.

2. The method according to claim 1, further comprising washing the crushed resin pieces with water and thereafter dewatering the crushed resin pieces.

3. The method according to claim 1, wherein the external dynamic energy comprises impact forces.

4. The method according to claim 3, the external dynamic energy further comprises vibrations and frictional forces.

5. A method of recycling a waste resin product having a coated film formed thereon, comprising:
roughly crushing the waste resin product into crushed resin pieces;
chemically removing the coated film at least partially from the crushed resin pieces;
finely crushing the crushed resin pieces after the chemical removal of the coated film; and
mechanically removing the coated film from the crushed resin pieces simultaneously with finely crushing the crushed resin pieces, so that the coated film is substantially removed.

6. A method for recycling a waste resin product having a coated film formed thereon, comprising:
roughly crushing the waste resin product into crushed resin pieces;
removing metal particles from the crushed resin pieces;
chemically removing the coated film from the crushed resin pieces;
finely crushing the crushed resin pieces into finely crushed resin pieces after the chemical removal step;
mechanically removing the coated film from the finely crushed resin pieces;
washing the finely crushed resin pieces with water;
dewatering the finely crushed resin pieces after the washing step;
separating the finely crushed resin pieces from the removed coated film;
mixing the finely crushed resin pieces with additives; and
molding the mixture of the finely crushed resin pieces and the additives into pellets.

7. The method according to claim 6, further comprising transferring the finely crushed resin pieces, which have been separated from the removed coated film, to a stock tank via a pipeline by using a flow of air flowing through the pipeline; and
the mixing step comprises premixing the finely crushed resin pieces supplied from the stock tank with the additives immediately before the molding step.
